(19) United States
(12) Patent Application Publication
(10) Pub. No.: US 2019/0124298 A1
(43) Pub. Date: Apr. 25, 2019

(54) IMAGE-PROVIDING SYSTEM, IMAGE-PROVIDING METHOD, AND PROGRAM

(71) Applicant: OPTiM Corporation, Saga-shi (JP)

(72) Inventor: Shunji SUGAYA, Tokyo (JP)

(21) Appl. No.: 16/227,130

(22) Filed: Dec. 20, 2018

Related U.S. Application Data
(63) Continuation of application No. PCT/JP2016/069970, filed on Jul. 6, 2016.

(51) Int. Cl. H04N 7/18; G02B 27/01; H04N 5/232

(52) U.S. Cl. CPC H04N 7/18; G02B 27/0172; G02B 2027/014; G02B 2027/0138; H04N 5/23203

(57) ABSTRACT

An image-providing system 1 includes a selecting unit 13 that selects at least one image-capturing device from among a plurality of image-capturing devices 2, according to a result obtained by capturing a field of view of a user on a user terminal 20, and a display unit that displays a captured image captured by the image-capturing device 2 selected by the selecting unit 13 on the user terminal 20. The selecting unit 13 selects the image-capturing device included in an image captured by the user terminal 20.

### CROSS-REFERENCE TO RELATED APPLICATION

This application is a continuation of PCT Application No. PCT/JP2016/069970 filed on Jul. 6, 2016, the entire contents of which are incorporated herein by reference.

### BACKGROUND

### (a) Field

The present invention relates to an image-providing system, an image-providing method, and a program therefor.

### (b) Description of the Related Art

As a technique for providing captured images, there is known in the art, for example, the method disclosed in Patent Document 1. In this method, an image of a work site captured by a worker terminal is displayed on a centralized supervisor terminal in a work site together with a work task check list. As a result, a supervisor is able to remotely monitor the work site.

Patent Document 1: Japanese Patent Application Publication No. 2016-115027

Use of the technique disclosed in Patent Document 1, requires that a supervisor carry out a manual operation at the centralized supervisor work terminal to select a work site, from among, for example, options such as work site A, work site B that he/she wishes to view. As a result the supervisor is subject to an undue burden of having to memorize a name of a work site that he/she wishes to view.

### SUMMARY

The present invention provides a technique and a mechanism for assisting selection of an image that a user wishes to view.

In the subject invention, there is provided an image-capturing system including a selecting unit that selects at least one image-capturing device from among a plurality of image-capturing devices, that are included in an image captured by a user terminal, and displayed on a display unit that displays on the user terminal an image captured by the image-capturing device selected by the selecting unit.

The selecting unit is able to select the image-capturing device included in the image captured by the user terminal.

When a plurality of image-capturing devices is included in the image captured by the user terminal, the selecting unit is able to select at least one image-capturing device according to a position of the image-capturing device in the image.

The selecting unit is able to select an image-capturing device that captures at least a part of the image captured by the user terminal.

The selecting unit is able to select an image-capturing device that is not included in the image captured by the user terminal but exists in an image-capturing direction of the user terminal.

After starting to display the image captured by the image-capturing device selected by the selecting unit on the user terminal, the display unit is able to continue to display the captured image regardless of an image subsequently captured by the user terminal.

A remote control unit that remotely controls the image-capturing device selected by the selecting unit may be provided.

The remote control unit is able to remotely control the image-capturing device in accordance with a movement of a head or eye of the user viewing the captured image displayed on the user terminal.

The display unit is able to allow a transmissive display panel to display the image captured by the image-capturing device at a position corresponding to the image-capturing device as viewed through the display panel.

Further, the present invention provides an image-providing method including a selecting step of selecting at least one image-capturing device from among a plurality of image-capturing devices, included in an image captured by a user terminal, and a display step of displaying on the user terminal an image captured by the image-capturing device selected in the selecting step.

Furthermore, in the present invention there is provided a program for causing one or more computers to execute a selecting step of selecting at least one image-capturing device from among a plurality of image-capturing devices, included in an image captured by a user terminal, and a display step of displaying on the user terminal an image captured by the image-capturing device selected in the selecting step.

According to the present invention, a user is assisted in selecting an image to be viewed.

### BRIEF DESCRIPTION OF THE DRAWINGS

FIG. 1 is a diagram exemplifying an overview of an image-providing system 1 according to an embodiment.

FIG. 2 is a diagram exemplifying a functional configuration of an image-providing system 1.

FIG. 3 is a diagram exemplifying a hardware configuration of a server 10.

FIG. 4 is a diagram exemplifying information stored in the storage unit 12.

FIG. 5 is a diagram exemplifying a hardware configuration of a user terminal 20.

FIG. 6 is a diagram exemplifying an appearance of a user terminal 20.

FIG. 7 is a sequence chart exemplifying an operation related to display of captured image data.

FIG. 8 is a diagram exemplifying a result captured by a user terminal 20.

FIG. 9 is a diagram exemplifying an image displayed on a user terminal 20.

FIG. 10 is a diagram exemplifying a result captured by a user terminal 20.

FIG. 11 is a diagram exemplifying an image displayed on a user terminal 20.

FIG. 12 is a diagram showing an example of superimposing images displayed on a user terminal 20 in a user's field of view.

FIG. 13 is a diagram exemplifying an image displayed on a user terminal 20.

FIG. 14 is a diagram showing an example of superimposing images displayed on a user terminal 20 in a user's field of view.

FIG. 15 is a diagram exemplifying a functional configuration of an image-providing system 1 according to a modified example 4.

### DESCRIPTION OF REFERENCE NUMBERS

1: image-providing system, 2: camera, 10: server, 11: image acquiring unit, 12: storage unit, 13: selecting unit, 14: providing unit, 15: remote control unit, 20: user terminal, 21: accepting unit, 22: requesting unit, 23: receiving unit, 24: display unit, 25: image-capturing unit, 90: network, 101: CPU, 102: RAM, 103: ROM, 104: auxiliary storage device, 105: communication IF, 201: CPU, 202: RAM, 203: ROM, 204: auxiliary storage device, 205: communication IF, 206: input device, 207: display device, 2071: display panel, 2072: projection device, 208: sensor, 209: camera, A: captured image, B: display image, U: user

### DETAILED DESCRIPTION OF THE EMBODIMENTS

1. Configuration

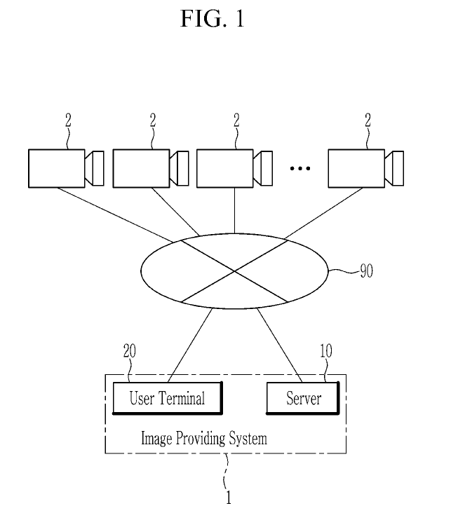

FIG. 1 is a diagram exemplifying an overview of an image-providing system 1 according to an embodiment of the present invention. The image-providing system 1 selects a camera within a range of a user's field of view from among a plurality of cameras arranged at various locations, and provides the user with an image captured by the selected camera. A user terminal used for displaying the image is, for example, a glasses-type wearable terminal that can be worn by the user as a head set. A camera situated in a direction toward a face of the user wearing the user terminal is selected as the camera within the range of the user's field of view. As a result, the user is able to readily look at a camera deemed likely to cover a space that the user wishes to view, thereby enabling the user to browse an image of the space captured by the camera.

As shown in FIG. 1, the image-providing system 1 is connected to a plurality of cameras 2 via a network 90. Each of the cameras 2 is an image-capturing device for capturing an image and may be installed either indoors or outdoors. The cameras 2 continuously capture a periphery view within their installation location and output a captured image of the peripheral view. In one embodiment, the image is a moving image, but the image may also be a still image. Hereafter, an image captured by one of the cameras 2 will be referred to as a “captured image,” and data of the captured image will be referred to as “captured image data.” The network 90 can be any network as long as it serves to connect the cameras 2, a server 10, and a user terminal 20. The network 2 is, for example, the Internet, a LAN (Local Area Network), a WAN (Wide Area Network), or a combination thereof, and can include a wired section or a wireless section. A plurality of user terminals 20 can be provided.

The image-providing system 1 includes the server 10 and the user terminal 20. The server 10 provides the user terminal 20 with a captured image outputted from at least one camera 2 selected from among a plurality of captured images outputted from the plurality of cameras 2. The user terminal 20 is a device that functions as a client of the image-providing system 1. The user terminal 20 receives an instruction from the user, captures an image of a space corresponding to the user's field of view, and displays the image to the user. The purpose of viewing the image displayed on the user terminal 20 is not particularly limited and can be of any purpose. However, for example, in a case where work is being performed in the space captured by at least one of the cameras 2, the main purpose is to monitor, observe, support, or assist the work being performed.

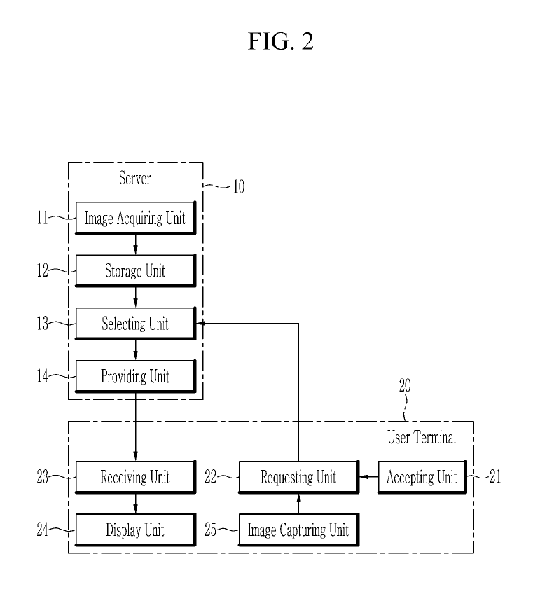

FIG. 2 is a diagram exemplifying a functional configuration of an image-providing system 1. The image-providing system 1 includes an image acquiring unit 11, a storage unit 12, a selecting unit 13, a providing unit 14, an accepting unit 21, a requesting unit 22, a receiving unit 23, a display unit 24, and an image-capturing unit 25. In this example, in the image-providing system 1, the image acquiring unit 11, the storage unit 12, the selecting unit 13, and the providing unit 14 are implemented in the server 10, and the receiving unit 21, the requesting unit 22, the receiving unit 23, the display unit 24, and the image-capturing unit 25 are implemented in the user terminal 20.

The image acquiring unit 11 acquires an image captured by at least one of the cameras 2 via a network 90. The storage unit 12 stores various types of information including captured image data. The accepting unit 21 accepts an instruction for requesting the captured image from the user. The image-capturing unit 25 captures an image of a space corresponding to the user's field of view. In response to the instruction accepted by the accepting unit 21, the requesting unit 22 transmits a request for the captured image to the server 10. The request includes information (the captured image in this case) corresponding to a result captured by the image-capturing unit 25. The selecting unit 13 selects at least one camera 2 from among the plurality of cameras 2 in accordance with a result obtained by capturing the user's field of view by the user terminal 20. More specifically, the selecting unit 13 selects a camera 2 included in the image captured by the user terminal 20. The providing unit 14 provides the user terminal 20 with the captured image data of the camera 2 selected by the selecting unit 13. The receiving unit 23 receives the captured image data provided by the providing unit 14. The display unit 24 displays the captured image data received by the receiving unit 23 on the user terminal 20.

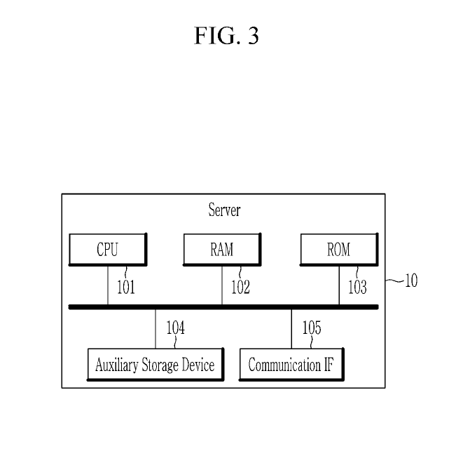

FIG. 3 is a diagram exemplifying a hardware configuration of a server 10. The server 10 is a computer device including a CPU (Central Processing Unit) 101, a RAM (Random Access Memory) 102, a ROM (Read Only Memory) 103, an auxiliary storage device 104, and a communication IF 105. The CPU 101 is a processor that performs various operations. The RAM 102 is a volatile memory that functions as a work area when the CPU 101 executes a program. The ROM 103 is, for example, a nonvolatile memory that stores a program and data used for starting the server 10. The auxiliary storage device 104 is a nonvolatile storage device that stores various programs and data, and includes, for example, a HDD (Hard Disk Drive) and a SSD (Solid State Drive). The communication IF 105 is an interface that performs communication via the network 90 in accordance with a predetermined communication standard.

In this example, the auxiliary storage device 104 stores a program (hereafter, “server program”) that causes the computer device to function as a server in the image-providing system 1. The CPU 101 executes the server program thereby implementing the functions shown in FIG. 2. The CPU 101 executing the server program is an example of the image-acquiring unit 11, the selecting unit 13, and the providing unit 14. The auxiliary storage device 104 is an example of the storage unit 12.

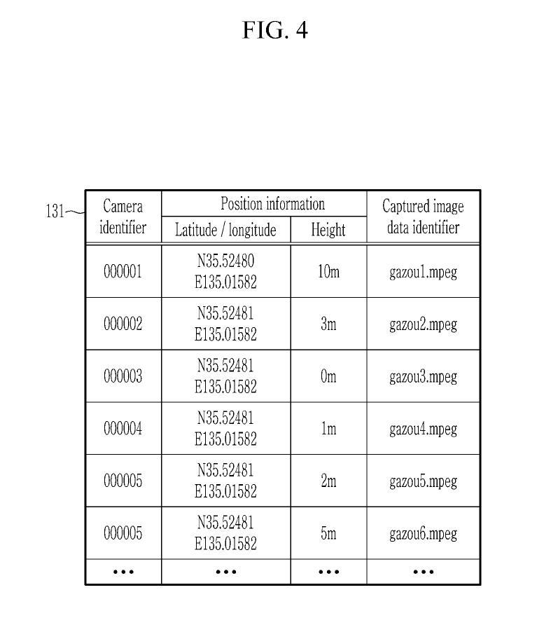

FIG. 4 is a diagram exemplifying information stored in a storage unit 12. The storage unit 12 stores in association with each other a camera identifier, position information, and a captured image data identifier. The camera identifier is information for identifying a camera 2. The position information is information indicating an installation position of the camera 2. In the example shown in FIG. 4, the position information includes each of a latitude and a longitude of the position of the camera 2, and also a height (height from the ground) of the camera 2. The captured image data identifier is information for identifying the captured image data representing the image captured by the camera 2, and in this example is a file name of the captured image data.

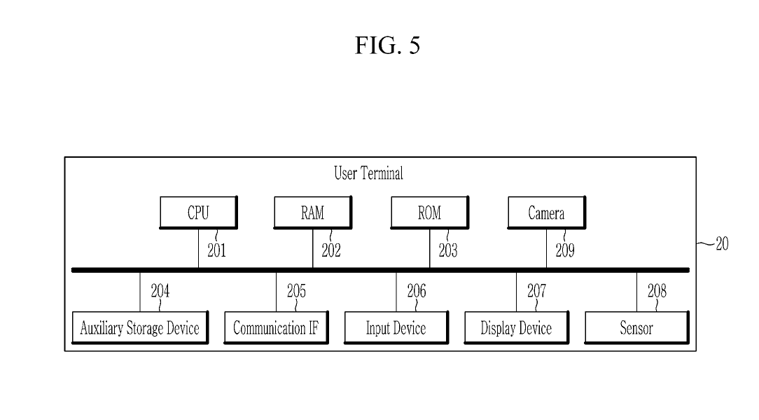

FIG. 5 is a diagram exemplifying a hardware configuration of a user terminal 20. The user terminal 20 is a computer device including a CPU 201, a RAM 202, a ROM 203, an auxiliary storage device 204, a communication IF 205, an input device 206, a display device 207, a sensor device 208, and a camera 209. The CPU 201 is a processor that performs various operations. The RAM 202 is a volatile memory that functions as a work area when the CPU 201 executes a program. The ROM 203 is, for example, a nonvolatile memory that stores a program and data used for starting the user terminal 20. The auxiliary storage device 204 is a nonvolatile storage device that stores various programs and data, and includes at least one of, for example, an HDD and an SSD. The communication IF 205 is an interface that performs communication via the network 90 in accordance with a predetermined communication standard. The communication standard may be a wireless communication standard or a wired communication standard. The input device 206 is a device for input by a user of an instruction and information to the CPU 201, and includes, for example, at least one of a touch sensor, a key, a button, and a microphone. The display device 207 is a device that displays information, and includes, for example, an LCD (Liquid Crystal Display). The sensor 208 is a means for sensing a position of the user terminal 20 and an orientation of a face of a user wearing the user terminal 30, and includes, for example, a positioning device such as a GPS (Global Positioning System), and an orientation detection device such as a gyro sensor and a geomagnetism sensor. The camera 209 captures an image of a space in a direction faced by the user, that is, a space corresponding to the user's field of view.

In this example, the auxiliary storage device 204 stores a program (hereinafter, “client program”) that causes the computer device to function as a client in the image-providing system 1. The CPU 201 executes the client program thereby implementing the functions shown in FIG. 2. The CPU 201 executing the client program is an example each of the accepting unit 21 and the requesting unit 22. The communication IF 205 is an example of the receiving unit 23. The display device 207 is an example of the display device 24. The image-capturing device 209 is an example of the image-capturing unit 25. The sensor 208 is an example of the requesting unit 22.

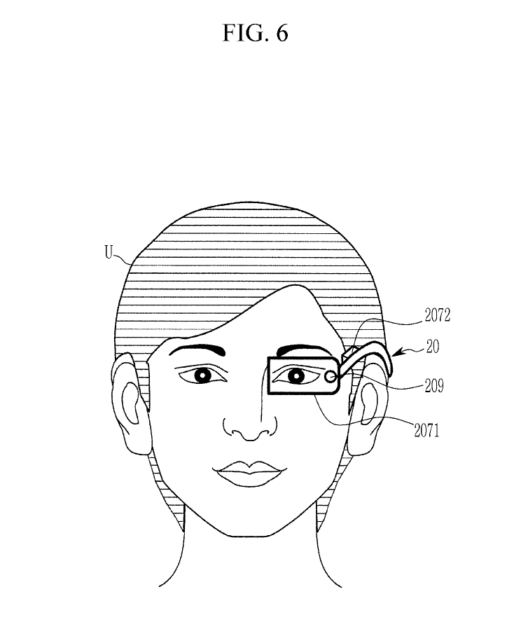

FIG. 6 is a diagram exemplifying an appearance of a user terminal 20. The user terminal 20 is a so-called glasses-type wearable terminal. The user terminal 20 is worn as a head set by a user U, more specifically, as an eye piece in the vicinity of one eye of the user U. The display device 207 includes a display panel 2071 and a projection device 2072. The display panel 2071 is a transmissive panel member that transmits light, and an image projected from the projection device 2072 is projected and displayed on the display panel 2071. The user U can view a space in front of the user U as transmitted through the display panel 2071, and can also view the image displayed on the display panel 2071. That is, the user U can focus an eye on the space when viewing the space in front of the user U, and can focus the eye on a position of the display panel 2071 when viewing the image displayed on the display panel 2071. Further, the display device 207 is not limited to a display device that projects the image from the projection device 2072 on the transmissive display panel 2071, and may consist of other display devices such as a small liquid crystal display provided with a display surface for the eye of the user U. When the user terminal 20 is worn as an eye piece by the user U, the camera 209 is located at a position near the eye of the user U, and captures an image of a space substantially coincident with a field of view of the user U. The image captured by the camera 209 is used by the selecting unit 13 of the server 10 to select at least one of the cameras 2.

2. Operation

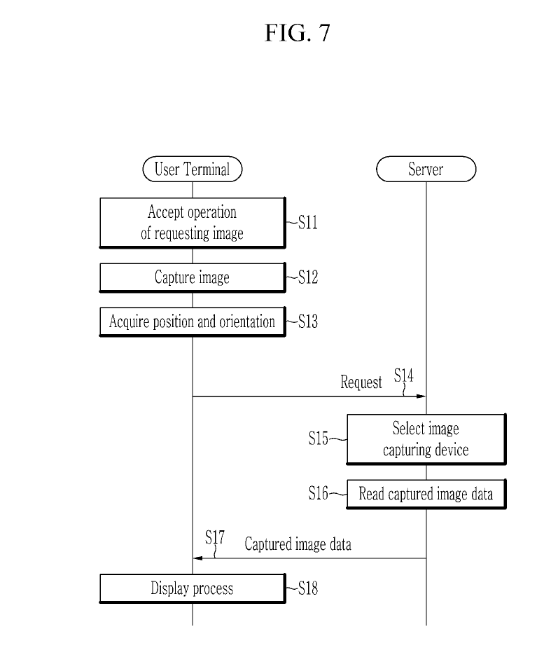

FIG. 7 is a sequence chart showing an operation of an image-providing system 1 according to an embodiment. Each of the cameras 2 continuously transmits captured image data to a server 10 in real time. The captured image data include, in addition to the data representing the captured image, attribute information on the camera 2 that has captured the image, for example, a camera identifier. In step S11, the image-acquiring unit 11 of the server 10 acquires the captured image data from each of the cameras 2. Here, acquiring the captured image means acquiring the captured image data via the network 90 and storing the acquired captured image data at least temporarily in the storage unit 12. In this example, since the cameras 2 continuously output captured image data, the image-acquiring unit 11 continuously acquires the captured image data.

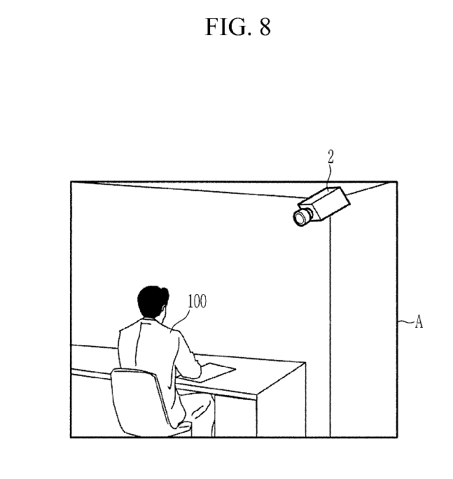

On the other hand, if there is a space that the user wishes to view when the user terminal 20 is worn as an eye piece by the user, the user generally specifies a camera 2, from among the plurality of cameras 2, which appears able to capture an image of a space, based on a relationship of an orientation or distance of a lens of each camera 2 with respect to the space, and looks at that camera 2. FIG. 8 is a diagram showing the user's field of view A at this time. Here, it is assumed that the user wishes to view a work state of a worker 100, and the specified camera 2 is capturing an image of a space of the worker. When the user performs an operation of requesting an image on an accepting unit 21 in such a field of view, the accepting unit 21 of the user terminal 20 accepts the operation in step S11. In accordance with this operation, the image-capturing unit 25 captures an image of the space corresponding to the user's field of view A and generates the captured data in step S12. Next, the requesting unit 22 acquires a position and orientation of the user terminal 20 sensed by a sensor 208 in step S13, and transmits a request including the position, the orientation, and the captured data to the server 10 in step S14.

Upon receiving the request, a selecting unit 13 of the server 10 selects a camera 2 included in the image captured by the user terminal 20 in step S15. Specifically, the selecting unit 13 determines a range of the space captured by the user terminal 20 based on a position and orientation of the user terminal 20 included in the request. Next, the selecting unit 13 extracts an image corresponding to the camera 2 from the image represented by the captured data by an image recognition technique such as pattern matching, and specifies a position of the camera 2 in the extracted image. The selecting unit 13 then compares the position of the camera 2 in the range of the captured space with position information of each camera 2 stored in an auxiliary storage device 104, and selects a camera 2 whose position matches an area within a predetermined error range. A providing unit 14 reads captured image data from the selected camera 2 from a storage unit 12 based on a captured image data identifier at step S16, and transmits the captured image data to the user terminal 20 in step S17.

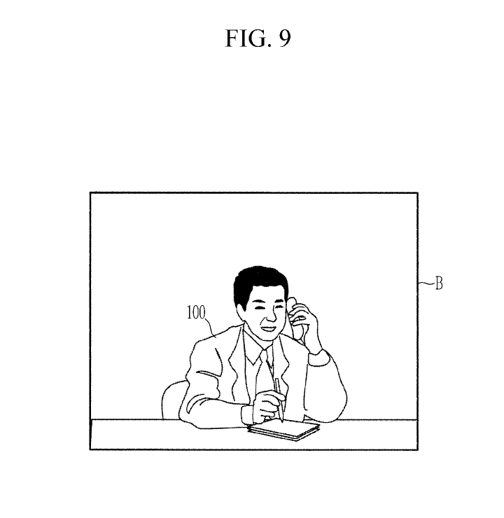

In step S18, a display unit 24 of the user terminal 20 displays an image corresponding to the captured image data received by the receiving unit 23. FIG. 9 is a diagram showing an image displayed at this time on the user terminal 20. As shown in FIG. 9, the work state of the worker 100 as viewed by the selected camera 2 is displayed as an image. Accordingly, the user can view the work state of the worker captured at an angle, which would otherwise not be visible in detail from its own position. As a result, the user can, for example, readily monitor, observe, support, or assist the work of the worker.

If the operation of requesting the image is accepted in step S11 and selection of the (ok) camera 2 is confirmed in step S15, the selecting unit 13 continues to select the same camera 2. Therefore, after starting to display the captured image of the camera 2 selected by the selecting unit 13, the display unit 24 of the user terminal 20 continues to display the captured image of the selected camera 2 regardless of a result captured by the user terminal 20. Thus, even if the user changes a face orientation such that the camera 2 is no longer within the user's field of view, a range of space displayed on the user terminal 20 does not change Here, when the user wishes to view a different space, the user looks at a camera 2 that is deemed likely to capture an image of the different space and again performs an operation of requesting an image. As a result, the above-described processing is repeated from step S11 whereby a new camera 2 is selected.

According to the present embodiment, it is possible to assist a user in the selection of the image that the user wishes to view. In other words, the user is able to intuitively select a camera depending on the user's field of view and can thus view the image captured by the camera.

3. Modified Examples

The present invention is not limited to the above-described embodiments, and various modified examples are possible. Several possible modified examples are described below. Two or more of the following modified examples may be combined for use.

3-1. Modified Example 1

In an embodiment, a selecting unit 13 selects a camera 2 included in an image captured by a user terminal 20. Here, the selection method of the camera 2 is not limited to an example of an embodiment, and can be any one as long as at least one of the plurality of cameras 2 is selected according to a result obtained by capturing the user's field of view by the user terminal 20. For example, a bar code, a character string, a figure, or the like, indicating a camera identifier can be attached (displayed) on a casing of each camera 2, and the selecting unit 13 is able to select the camera 2 based on the camera identifier included in an image captured by the user terminal 20. In addition, in a case where shapes, colors, or the like of the cameras 2 are different and thus each of the cameras 2 can be identified, the selecting unit 13 is able to select a camera 2 included in the user's field of view based on the shape or color of the camera 2 included in the image captured by the user terminal 20, and the shapes or colors of the cameras 2 that are stored in a storage unit 12 in advance. In these cases, a sensor 208 of the user terminal 20 is not required.

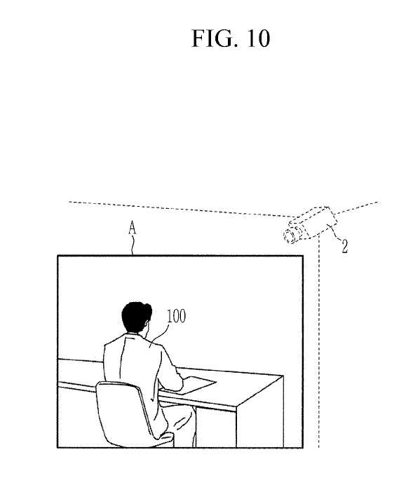

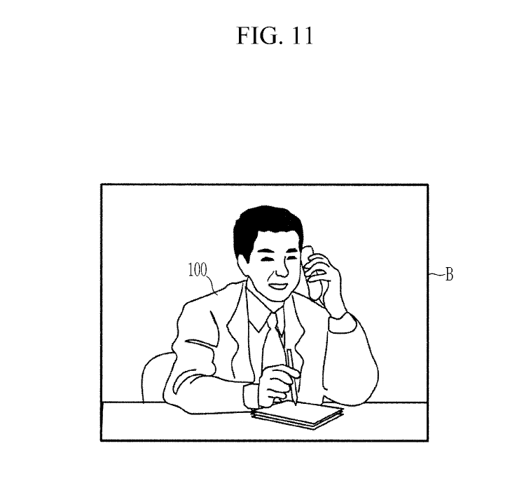

In addition, in an embodiment, the user puts a camera 2 that is deemed likely to capture a space that the user wishes to view into the user's field of view, so that an image of the space is displayed. Alternatively, the user can look in the direction of the space that the user wishes to view, so that the image of the space can be displayed on the user terminal 20. FIG. 10 is a diagram exemplifying the user's field of view A according to this modified example. Here, it is assumed that the user wishes to view a work state of a worker 100, and a camera 2 is capturing an image of the worker's space. However, even if the user does not put the camera 2 into the user's field of view, it is sufficient for the user to look in the direction of the space that the user wishes to view. For this purpose, the camera 2 indicated by a broken line in FIG. 10 is, for example, outside the user's field of view. When the user performs an operation of requesting an image under such the field of view, an accepting unit 21 accepts the operation in step S11 shown in FIG. 7. In response to this operation, the image-capturing unit 25 captures a space corresponding to the user's field of view A and generates the captured data in step S12. Next, a requesting unit 22 acquires a position and an orientation of the user terminal 20 using a sensor 208 in step S13, and transmits a request including the position, the orientation, and the captured data to the server in step S14. In step S15, a selecting unit 13 of the server 10 determines a range of the image captured space based on the position and orientation of the user terminal 20 included in the request. Next, the selecting unit 13 extracts a fixed object (for example, a workbench, a lighting device, or the like) included in the image from the image represented by the captured data by image recognition technology such as pattern matching, and specifies a position of the fixed object in the image. Position information of each fixed object is stored in an auxiliary storage device 104 (a storage unit 12) in advance, and a camera identifier of a camera 2 capturing an image of a space in which the fixed object exists is stored in association with the fixed object. The selecting unit 13 compares the position of the fixed object in the range of the captured space with the position information of each fixed object stored in the auxiliary storage device 104 (the storage unit 12), and specifies the fixed object whose position matches an area within a predetermined error range. The selecting unit 13 then selects a camera 2 according to the camera identifier corresponding to the specified fixed object. A providing unit 14 reads the captured image data corresponding to the selected camera 2 from the storage unit 12 in step S16, and transmits the captured image data to the user terminal 20 in step S17. FIG. 11 is a diagram exemplifying an image B displayed at this time. As shown in FIG. 11, the work state of the worker 100 viewed from a viewpoint of the camera 2 is displayed as an image. This image is an image capturing a space that overlaps with at least a part of the space (FIG. 10) captured by the user terminal 20. Thus, the user can put the space that the user wishes to see into the user's field of view, thereby seeing the space from a viewpoint different from the user's viewpoint. As described above, the selecting unit 13 is able to select the camera 2 capturing an image of a space overlapping at least a part of the space captured by the user terminal 20.

Further, the camera identifier such as the above-described bar code can be attached (displayed) to, for example, clothing or a hat of a worker, a work object, or the above-described fixed object, and the selecting unit 13 is able to select a camera 2 based on the camera identifier included in the image captured by the user terminal 20. In this case, the sensor 208 of the user terminal 20 is not required.

3-2. Modified Example 2

In a case where a plurality of cameras 2 are included in an image captured by a user terminal 20, the following can be performed.

For example, when the plurality of cameras 2 is included in the image captured by the user terminal, a selecting unit 13 selects at least one camera 2 according to a position of each camera 2 in the image. Specifically, in a case where the plurality of cameras 2 is included in the image captured by the user terminal 20, for example, a camera 2 closer to a specific position that is at a center of the image (i.e., a center of a line of sight of the user) is selected. The specific position can be determined based on criteria other than the center of the image.

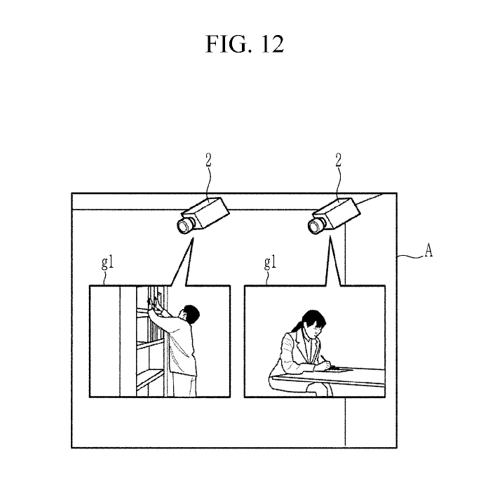

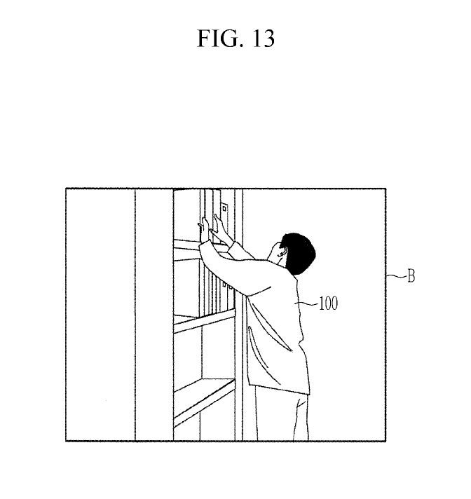

Further, the captured image captured by the at least one camera 2 can be displayed at a position corresponding to a camera 2 that is viewed by the user through a display panel 2071. Specifically, as shown in FIG. 12, a display unit 24 displays, as so-called thumbnail images, the captured images g1 and g2 of these cameras 2 in a small size in the vicinity of each camera 2 in the user's field of view A. Then, if any one of the cameras 2 (here, the camera 2 corresponding to the captured image g1) is designated by the user's operation, an enlarged image of the captured image g1 is displayed on the user terminal 20 as shown in FIG. 13.

The specific processing is as follows. In step S12 of FIG. 7, an image-capturing unit 25 captures image data of a space corresponding to the user's field of view A and generates the captured data. A requesting unit 22 acquires a position and orientation of the user terminal 20 using a sensor 208 in step S13, and transmits a request including the position, the orientation, and the captured data to the server 10 in step S14. In step S15, a selecting unit 13 of the server 10 determines a range of the space encompassed by the captured data based on the position and orientation of the user terminal 20 included in the request. Next, the selecting unit 13 extracts a camera 2 from the image represented by the captured data by image recognition technology, and specifies a position of the camera 2 in the image. The selecting unit 13 then compares the position of the camera 2 in the range of the space encompassed by the captured data with position information of each camera 2 stored in an auxiliary storage device 104, and selects a camera 2 (here, a plurality of cameras 2) whose position matches an area within a predetermined error range. In step S16, a providing unit 14 reads the captured image data corresponding to the selected cameras 2 from a storage unit 12, and transmits to the user terminal 20 the captured image data together with the position information of the cameras 2 in the captured image. In step S18, a display unit 24 of the user terminal 20 displays the captured image data received by a receiving unit 23 in an area below the position of each camera 2 in the user's field of view. If the user designates any one of the cameras 2 in the user terminal 20, the providing unit 14 reads the captured image data corresponding to the selected camera 2 from the storage unit 12, and transmits the captured image data to the user terminal 20. The display unit 24 of the user terminal 20 displays the captured image data received by the receiving unit 23.

3-3. Modified Example 3

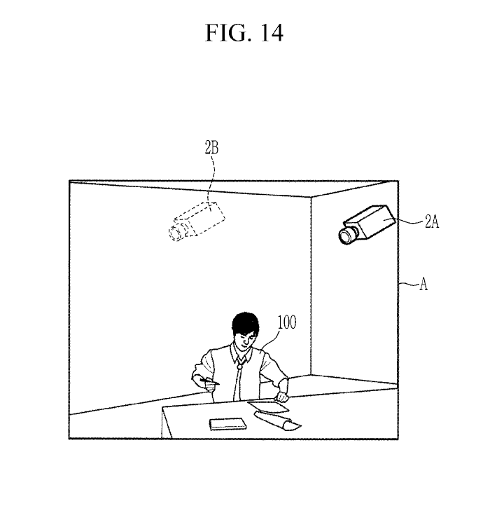

A captured image of the camera 2, which is located in a room different from a room in which a user is present and cannot be directly seen by the user, is able to be displayed. In other words, a selecting unit 13 is able to select a camera 2 that is not included in the image captured by the user terminal 20 but exists in an image-capturing direction of the user terminal 20. FIG. 14 shows an example in which a camera 2A is located in a room in which the user is present is visible in the user's field of view A, and a camera 2B in a next room is displayed. In this case, an image-capturing unit 25 captures image data of a space corresponding to the user's field of view A and generates captured data in step S12 of FIG. 7. A requesting unit 22 acquires a position and orientation of the user terminal 20 using a sensor 208 in step S13, and transmits a request including the position, the orientation, and the captured data to the server 10 in step S14. In step S15, a selecting unit 13 determines a range of the space encompassed by the captured data based on the position and orientation of the user terminal 20 included in the request. Next, the selecting unit 13 extracts a camera 2 from the image represented by the captured data by image recognition technology, and specifies a position of the camera 2 in the image. The selecting unit 13 then compares the position of the camera 2 in the range of the space encompassed by the captured data with position information of each camera 2 stored in an auxiliary storage device 104, and selects the camera 2 (here, the camera 2A) whose position matches an area within a predetermined error range. Furthermore, the selecting unit 13 selects all the cameras (here, the camera 2B in the next room) existing in the image-capturing direction of the user terminal 20, based on the range of the captured space and the position and orientation of the user terminal 20, and specifies a position of the camera 2B in the image-capturing direction. A providing unit 14 then transmits the position information of the selected camera 2B to the user terminal 20. A display unit 24 of the user terminal 20 displays a broken line image representing the appearance of the camera 2B at a position where the camera 2B appears to be present (FIG. 14). If the user designates the camera 2B in the user terminal 20, the providing unit 14 reads the captured image data corresponding to the selected camera 2 from a storage unit 12 and transmits the captured image data to the user terminal 20. The display unit 24 of the user terminal 20 displays the captured image data received by a receiving unit 23.

3-4. Modified Example 4

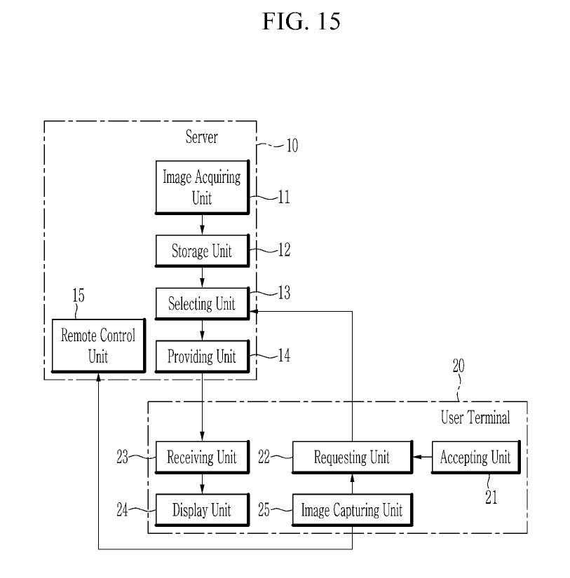

A remote control unit can be provided for remotely controlling a camera 2 selected by a selecting unit 13, in accordance with a movement of a user who views a captured image displayed in a user terminal 20. In particular, when the user terminal 20 is a wearable terminal worn as an eye piece by the user, the remote control unit remotely controls the camera in accordance with the movement of the head or eye of the user viewing the captured image displayed in the user terminal 20. FIG. 15 is a diagram exemplifying a functional configuration of an image-providing system 1 according to modified example 4. In addition to the functions exemplified in FIG. 2, the image-providing system 1 includes a remote control unit 15. A CPU 101 of a server 10 is an example of the remote control unit 15. After the camera 2 is selected, upon viewing the captured image and wishing to view further, for example, a lower right side of the captured image, the user turns his/her head to the lower right so as to face the side that the user wishes to view. A requesting unit 22 acquires, as information indicating the movement of the user's head, a position and orientation of the user terminal 20 using a sensor 208, and transmits a request including the position, the orientation, and the captured data to the server 10. The remote control unit 15 of the server 10 drives an attitude control device of the camera 2 to adjust its position and orientation, thereby moving the image-capturing direction of the camera 2 in the lower right direction as seen from the image center. Thus, the user is able to intuitively change the space captured by the camera 2.

3-5. Other Modified Examples

The camera 2 is not limited to one exemplified in an embodiment. The camera 2 need not be fixed at a specific position but can be a device carried by the user, for example, a smartphone or a digital camera, or may be mounted on a moving object such as a drone.

The user terminal 20 is not limited to a wearable terminal, and can be, for example, a smartphone or a digital camera, or may be mounted on a moving object such as a drone.

A positioning device and orientation detection device provided in the sensor 208 are not limited to the GPS, the gyro sensor, and the geomagnetism sensor exemplified in an embodiment, but can be any device as long as it performs the position and orientation detection of the user terminal 20.

In the user terminal 20, the display unit 24 is able to display information different from the captured image data, together with the captured image data. This information can be information related to the worker or information related to the work of the worker. Specifically, the information can be a name or a work name of the worker.

A part of the functional configuration exemplified in FIG. 2 can be omitted. For example, the storage unit 12 can be provided by an external server different from the image-providing system 1. Further, the functions of the server 10 and the user terminal 20 are not limited to those exemplified in FIG. 2. In an embodiment, some of the functions implemented in the server 10 can be implemented in the user terminal 20. Furthermore, a server group that physically consists of a plurality of devices can function as the server 10 in the image-providing system 1.

Programs executed by the CPU 101, the CPU 201, and the like can be provided by a storage medium such as an optical disk, a magnetic disk, a semiconductor memory, or the like, or can be downloaded via a communication line such as the Internet. Further, the programs may not execute all the steps described in an embodiment. A set of the server program and the client program is an example of a program group for causing the server and the client terminal to function as the image-providing system.

1. An image-providing system comprising:
a selecting unit that determines a range of a space captured by a user terminal, and selects an image-capturing device, which captures a space overlapping at least a part of the range of the determined space, from among a plurality of image-capturing devices; and
a display unit that displays a captured image captured by the image-capturing device selected by the selecting unit on the user terminal.

2. The image-providing system according to claim 1, wherein the selecting unit compares a position of a fixed object in the range of the space captured by the user terminal with a stored position of the fixed object, and selects the image-capturing device by an identifier of the fixed object having a position and a stored position that match a space within a predetermined error range.

3. The image-providing system according to claim 1, wherein after starting to display the captured image captured by the image-capturing device selected by the selecting unit on the user terminal, the display unit continues to display the captured image regardless of a result captured by the user terminal.

4. The image-providing system according to claim 1, further comprising a remote control unit that remotely controls the image-capturing device selected by the selecting unit, in accordance with a movement of the user viewing the captured image displayed on the user terminal.

5. The image-providing system according to claim 4, wherein the user terminal is a wearable terminal worn as an eye piece by the user, and
wherein the remote control unit remotely controls the image-capturing device in accordance with a movement of the head or an eye of the user viewing the captured image displayed on the user terminal.

6. The image-providing system according to claim 1, wherein the display unit includes a transmissive display panel and displays the captured image captured by the image-capturing device at a position corresponding to the image-capturing device that is seen through the display panel by the user.

7. An image-providing method comprising:
a selecting step of determining a range of a space captured by a user terminal, and selecting an image-capturing device, which captures a space overlapping with at least a part of the range of the determined space, from among a plurality of image-capturing devices; and
a display step of displaying a captured image captured by the image-capturing device selected in the selecting step on the user terminal.

8. A program for causing one or more computers to execute:
a selecting step of determining a range of a space captured by a user terminal, and selecting an image-capturing device, which captures a space overlapping with at least a part of the range of the determined space, from among a plurality of image-capturing devices; and
a display step of displaying a captured image captured by the image-capturing device selected in the selecting step on the user terminal.

9. (canceled)

10. (canceled)

11. (canceled)

12. (canceled)
